(19) United States
(12) Patent Application Publication
(10) Pub. No.: US 2025/0233857 A1
(43) Pub. Date: Jul. 17, 2025

(54) SYSTEM AND METHOD FOR REAL-TIME IDENTIFICATION, BEHAVIORAL ANALYSIS, AND LOCATION-BASED SERVICES USING MULTI-LAYERED ANALYTICS

(71) Applicant: Regina DeBellis, Staten Island, NY (US)

(72) Inventor: Regina DeBellis, Staten Island, NY (US)

(21) Appl. No.: 19/017,132

(22) Filed: Jan. 10, 2025

Related U.S. Application Data
(60) Provisional application No. 63/619,941, filed on Jan. 11, 2024.

(51) Int. Cl. H04L 9/40

(52) U.S. Cl. CPC H04L 63/0861; H04L 63/105

(57) ABSTRACT

A system for identifying individuals using facial recognition is disclosed, including at least one user computing device in operable connection with a user network. An application server is in operable communication with the user network to host an application program for identifying and verifying individuals. The application program includes a user interface module for providing access to the application program via the at least one user computing device. A processor and a non-transitory, computer readable memory stores instructions that, when executed by the processor upon a user selection, cause the device to capture an image of an individual and reference the image of the individual with a database of images. The identity of the individual is then verified via an identification and verification module.

### CROSS-REFERENCE TO RELATED APPLICATIONS

The present application claims priority to U.S. Provisional Application No. 63/619,941 filed Jan. 11, 2024, titled “SYSTEM AND METHOD FOR IDENTIFYING AND VERIFYING INDIVIDUALS USING FACIAL RECOGNITION” which is hereby incorporated by reference in its entirety.

### TECHNICAL FIELD

The embodiments disclosed herein generally relate to systems and methods for identifying and verifying individuals, and more specifically relates to systems and methods for real-time identification, verification, and behavioral monitoring using facial recognition, internet data scrubbing, geolocation, and device-to-device communication technologies.

### BACKGROUND

Advances in network and communications technologies have greatly increased the convenience of security, especially when verifying identities, transactions, and a chain of custody. Current identifications and behavioral systems often lack real-time capabilities, robust data integration, and practical applications across devices and use cases.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein disclose a system for identifying individuals using facial recognition is disclosed, including at least one user computing device in operable connection with a user network. An application server is in operable communication with the user network to host an application program for identifying individuals using a verification module. The application program includes a user interface module for providing access to the application program via the at least one user computing device. A processor and a non-transitory, computer readable memory stores instructions that, when executed by the processor upon a user selection, cause the device to determine the identity of an individual and verify their identity using a comparator to reference and verify the individual.

The embodiments provide a unified, multifunctional system which is capable of the real-time identification of individuals using facial recognition and internet data scrubbing. The system also provides behavioral analysis through user-driven flagging and pattern recognition to aid in the identification of individuals and the determination of if the individual(s) is/are capable of performing a task (i.e., is the person verified as the intended individual for a task). The system also provides proximity detection using near-frequency communication protocols (e.g., Bluetooth), ultrasound, geolocation, etc. The system is also capable of linking social media and/or internet data to user profiles for comprehensive insights.

In one aspect, the system may be used to provide a chain of custody for an item. The chain of custody may be automatically updated using the system such that the location of the item may be updated in real-time. Further, the system may automatically update the individual, business, or other entity which has custody of the item.

The application program allows users to identify and verify the identity of other users of the system. Users may connect with one another, transmit messages to one another, find the location of other users, etc.

In one aspect, the system may be used to monitor the location of an individual throughout a transfer process. For example, the system may be used by a parent or guardian to monitor the location of a child who is being transported to a location (e.g., a school). In one example, the system may allow the parent or guardian to identify and verify the identity of a bus driver, and then monitor the child's location and eventual delivery to the school or other location. The system may also identify and verify the identity of the recipient (i.e., the school, administrator, teacher, caretaker, etc.) of the child to ensure that the child has reached the appropriate destination.

In one aspect, the system may be used to monitor the location of an item (such as a firearm) which is being transported. In such an example, the user may first identify and verify transporter who is tasked with transporting the firearm. The firearm, including the serial number and other identifying features are logged in the system and associated with the transporter. During the shipping process, the user is updated with the status of the transportation of the firearm. This may be especially useful for firearm manufacturers, law enforcement, and other governing entities when the shipment of firearms must be monitored and logged into a database. The system may also identify and verify the recipient at the time of delivery of the item to ensure that the item is delivery to the appropriate individual, business, or other entity.

In one aspect, users may track the habits, tendencies, and behavior of other users.

In one aspect, users are associated with one another, and notifications may be sent to each associated user which are related to the other users' actions.

In one aspect, the system may be used by daycares, schools, nurseries, etc. and will enable parents or guardians to identify new staff members before leaving their child in the care. Staff members will be identified and verified by the system before the parents or guardian leaves the child in their care. This may also allow the daycare (or other caretaker) to identify and verify the parent(s) or guardian(s) who are dropping off and picking up the child to ensure the chain-of-custody of the child is verified. In such, the system prevents unwanted persons from gaining custody of the child. This process may be accomplished using biometric scanning, or other verification processes as described by the various embodiments presented herein. Once the parent, guardian, caretaker, and/or child (including any combination thereof) have been verified, the system will transmit a notification that the verification process is complete.

In one aspect, the system includes a behavioral analysis module which is capable of analyzing an individual's behavior. Further, users may flag the individual (e.g., using a red or green flag), such that the user can identify permitted and non-permitted individuals.

In one aspect, the system may include a location module capable of determining the proximity of devices and/or users to a predefined location, or devices and/or users within a predefined radius.

In one aspect, a geolocation module is capable of monitoring and/or identifying user locations and/or movements. The geolocation module may be used to enable the user to “check-in”, “check-out”, etc. of a specific location. The information provided by the geolocation module may be used to monitor a user's movements, monitor their entrance and/or exit from a location, and otherwise monitor the user's location.

In one aspect, a data integration module may be used to search, query, scrub, and otherwise identify information contained in social media profiles, internet databases, public databases, etc. This may be used to verify the user's identity, verify credentials, etc.

The system, in some aspects, includes a blockchain-integration system to enhance and store communications, marketplace transactions, and user authentication events on a blockchain ledger. By leveraging blockchain technology, the application program ensures data immutability, secure communication, transparent transactions, and advances user privacy. In such, the application decentralized technology to enable secure social interactions, perform real-time identity verification, and store (via a blockchain ledger) tamper-proof records. The system may also incorporate smart contracts to automate processes such as post sharing, transaction validation, and user permission management.

The utilization of a decentralized data management system (i.e., the blockchain) and encryption protect against and hacking and unauthorized access to the system, its users, and data. The blockchain allows users to audit engagement metrics, message histories, and transaction records. Further, the blockchains modular design supports scalability to support future features and third-party integrations, ensuring long-term adaptability.

The system includes a virtual marketplace to provide a secure, user-driven platform that allows individuals to buy, sell, and trade goods or services, including tickets, through the application. The marketplace leverages live face scanning and the broader identification and verification features of the system to ensure safe transactions.

The marketplace provides a secure platform designed to facilitate safe buying and selling of goods, services, and tickets through the integration of advanced biometric verification, blockchain technology, and geolocation services. This marketplace leverages the core features of, including live face scanning, user behavior analysis, and proximity detection, to create a secure and transparent environment for transactions.

This addition ties directly into the overarching theme of the system as a secure, identification-based application while broadening its functionality to include marketplace capabilities. The marketplace is capable of performing secure user verification for each user listing an item for sale. Users undergo live face scanning for identity verification, ensuring all participants are verified. Similarly, buyers are verified before completing transactions, preventing fraud or impersonations.

The marketplace provide listing and browsing capabilities allows users to create detailed listings for goods, services, or tickets, with options to include images, descriptions, and pricing. This allows potential buyers to browse items within a predefined proximity (e.g., 5 miles) or expand the search radius.

The marketplace uses a geolocation and proximity detection module to integrate proximity detection and geolocation services to show listings based on the buyer's current location. Users can opt to meet in-person for transactions, with location tracking enabled for both parties during the meeting.

The marketplace logs all transactions with timestamps, user identities, and geolocation data. Notifications are sent to both buyers and sellers upon completion of a transaction. The system flags suspicious activity using behavioral analysis (e.g., repeated cancellations or mismatched identity during face scan). If a flagged user attempts a transaction, the system sends alerts to the administrators.

The marketplace is integrated with the blockchain system to store marketplace transactions on a blockchain ledger for additional transparency and tamper-proof records. This feature is particularly useful for ticket sales, ensuring authenticity and preventing double-selling or counterfeit tickets.

The marketplace also enables secure in-app messaging related to transactions and the ability to leave ratings and reviews associated with a transaction.

The system may also include a social media platform in communication with the blockchain integration system. This allows for users to post content which is stored on the blockchain ledger and is assigned a unique blockchain identifier. The blockchain identifier links metadata (e.g., creator ID, timestamp, privacy settings, etc.) to the posted content and ensures the post cannot be altered post-submission.

The system is also used for identifying individuals and generating transaction reports and personalized photo books within a social commerce platform. The system includes at least one user computing device in operable connection with a user network. An application server is in operable communication with the user network to host an application program for identifying and verifying individuals, managing a plurality of marketplace transactions, and compiling user-generated content the application program having a user interface module for providing access to the application program via the at least one user computing device. A report generation module for compiling and displaying detailed transaction histories, including a plurality of sales data and plurality of purchases data. A content generation module for compiling user-generated content into one or more customizable photo books. A processor and a non-transitory, computer readable memory storing instructions that, when executed by the processor upon a user selection, cause the device to capture an image of an individual and reference the image of the individual with a database of images. The processor enables the verification of an individual's identity. A plurality of transaction metadata is stored, via a blockchain ledger, including a buyer identity and a seller identity, one or more time stamps, one or more transaction amounts, and one or more geolocations. The transaction reports are generated and displayed and are each searchable by one or more search criteria including one of the following: a date range, a transaction type, and a counterparty. A plurality of user-generated content is compiled into a customizable photo book which is securely logged and validated fir ownership of a plurality of selected content via a blockchain to prevent unauthorized reproduction or replication of the photo book. The system also enables the fulfillment of the photo book in a digital format or a physical format.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the application program in communication with the computing system, according to some embodiments; and

FIG. 3 illustrates a block diagram of the application program utilized for the generation of a photobook, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system for identifying and verifying an individual using facial recognition. During use, the system allows user to sign up for the application program which can be utilized to verify the identity of the individual. The application program stores user profiles including images of the users in a database. An image capture module allows the user to capture an image of the individual using a camera of a smart device. The image is transmitted to an identification and verification module to determine and verify the identity of the individual.

In some embodiments, the system may be used to monitor the location of an individual throughout a transfer process. For example, the system may be used by a parent or guardian to monitor the location of a child who is being transported to a location (e.g., a school). In one example, the system may allow the parent or guardian to identify and verify the identity of a bus driver, and then monitor the child's location and eventual delivery to the school or other location. The system may also identify and verify the identity of the recipient (i.e., the school, administrator, teacher, caretaker, etc.) of the child to ensure that the child has reached the appropriate destination.

In some embodiments, the system may be used to monitor the location of an item (such as a firearm) which is being transported. In such an example, the user may first identify and verify transporter who is tasked with transporting the firearm. The firearm, including the serial number and other identifying features are logged in the system and associated with the transporter. During the shipping process, the user is updated with the status of the transportation of the firearm. This may be especially useful for firearm manufacturers, law enforcement, and other governing entities when the shipment of firearms must be monitored and logged into a database. The system may also identify and verify the recipient at the time of delivery of the item to ensure that the item is delivery to the appropriate individual, business, or other entity.

In some embodiments, the application program may be utilized to indicate and identify other users in an area near the user. For example, the user may be able to see other users of the system within a predefined radius (e.g., 1 mile, 100 feet, etc.). This can be used to indicate areas that have other users which they may want to meet. Once the user meets the other user, they may capture the image of the other user and verify, using the identification and verification module, the identity of the other user. The system may generate a score (i.e., there is a 95% chance this user's identity is matched to their profile) using facial recognition.

In some embodiments, the system may utilize biometric scanning and analysis systems which are operable to identify and verify the identity of an individual. For example, the system may use a retina scanner to scan the retinas of individuals. One skilled in the arts will readily understand that various biometric scanning software may be utilized to identify and verify the individuals, including bio-identifying systems, facial recognition systems, retina scanning systems, etc. This may also include the scanning of identifiers (i.e., personal codes, QR codes, etc.) which are associated with individuals.

In some embodiments, the system may be used to perform multi-body scanning. This may allow the system to determine a number of individuals within an environment (i.e., a number of people within a building).

In some embodiments, the system may include a sensor array positioned around and/or within a building, environment, etc. to monitor and manage the access of individuals therein. For example, the system may monitor and manage access of a building. This may be used in combination with the biometric sensors described hereinabove. This functionality may be used for various purposes including to verify that an individuals has access to a school, verify that an individual has access to receive and/or transmit an item, etc.

In some embodiments, once the other user is identified, the system may transmit information related to this user (e.g., their age, personal information, marital status, etc.).

During use, the user signs into the application and registers using their personal information (i.e., name, age, location, image of their face, etc.).

In some embodiments, the user may be associated with one or more other users. In one example, user 1 is married to user 2. As user 1 signs up for the application program, a notification is transmitted to user 2 via the communication module 202. This notification may be used to confirm that user 1 and user 2 are married.

In some embodiments, the application program may be utilized to confirm the identity of a service provider. For example, a laborer has been scheduled from a company to visit the home of user 1. Once the laborer presents themselves, user 1 captures an image of the laborer. This image is used to verify the identity of the laborer to provide peace-of-mind to the user.

In some embodiments, the application program may be utilized by law enforcement. Images captured by law enforcement may be stored in the database and used for reference in the future.

In some embodiments, the application program includes audio capabilities to identify the individual using an audible sound which can be listened to by the user. This may be especially beneficial if the user is hearing impaired.

In some embodiments, the system transmits, via a communication module, a notification to update users of actions performed by other users they are associated with. For example, if user 1 is married to user 2, and user 1 deletes the application, user 2 is notified of this action.

In some embodiments, the communication module enables the transmission of notifications to various users of the system. In one example, the notification may confirm that a biometric scan or other verification process is complete, and the subject's identity has been verified (or in some cases not verified). This enables a verifiable chain-of-custody to be generated for the individual, the item, etc. being verified and verifies who has custody of the person and/or item.

In some embodiments, the verification of the person/item is assigned a date, time, location, and other identifying information which is associated with the chain-of-custody information. This allows the user to view and monitor the chain-of-custody information which relates to the transfer of custody of an individual (e.g., a child), or an item.

In some embodiments, the system may be used by daycares, schools, nurseries, etc. and will enable parents or guardians to identify new staff members before leaving their child in the care. Staff members will be identified and verified by the system before the parents or guardian leaves the child in their care. This may also allow the daycare (or other caretaker) to identify and verify the parent(s) or guardian(s) who are dropping off and picking up the child to ensure the chain-of-custody of the child is verified. In such, the system prevents unwanted persons from gaining custody of the child. This process may be accomplished using biometric scanning, or other verification processes as described by the various embodiments presented herein.

In some embodiments, the system may be used by event organizers, coordinators, theme parks, and other public attraction coordinators which can be used to monitor the location of individuals at the location at which the event/attraction is help. For example, the system may be used by a parent or guardian to monitor the location of a child at an event, confirm that the child has check-in or otherwise entered the event, etc. This allows the parent/guardian to confirm the location of their child, confirm and/or receive notification when their child leaves the event, and otherwise monitor their status when in transit to the event, when at the event, and after leaving the event.

In some embodiments, the system includes a behavioral analysis module which is capable of analyzing an individual's behavior. Further, users may flag the individual (e.g., using a red or green flag), such that the user can identify permitted and non-permitted individuals.

In some embodiments, a geolocation services module is capable of monitoring and/or identifying user locations and/or movements. The geolocation services module may be used to enable the user to “check-in”, “check-out”, etc. of a specific location. The information provided by the geolocation module may be used to monitor a user's movements, monitor their entrance and/or exit from a location, and otherwise monitor the user's location. The geolocation services module may also be capable of determining the proximity of devices and/or users to a predefined location, or devices and/or users within a predefined radius.

In some embodiments, the internet scrubbing module may be used to search, query, scrub, and otherwise identify information contained in social media profiles, internet databases, public databases, etc. This may be used to verify the user's identity, verify credentials, etc.

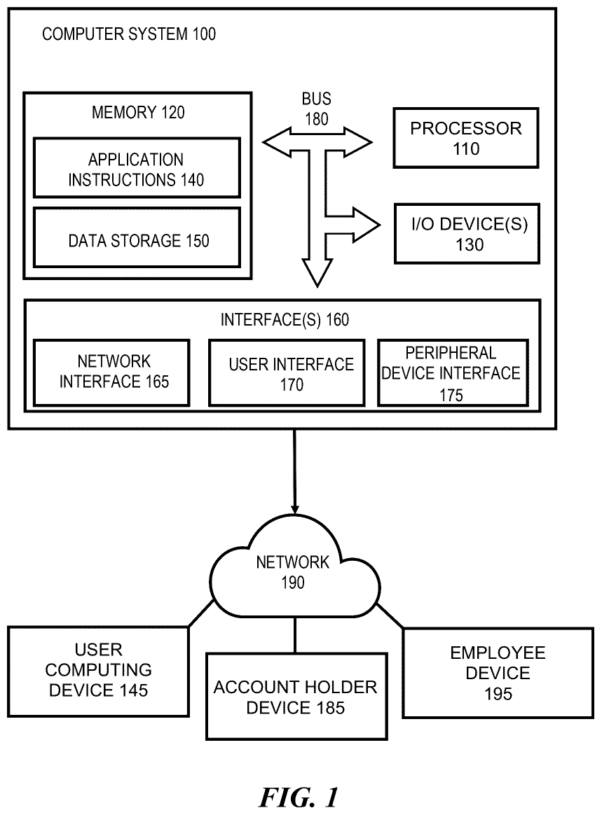

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

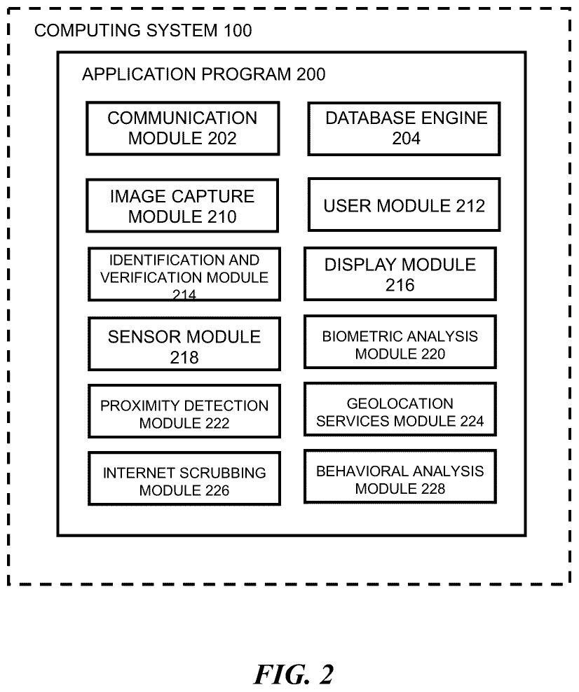

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, an image capture module 210, a user module 212, an identification and verification module 214, a display module 216, a sensor module 218, a biometric analysis module 220, a proximity detection module 222, a geolocation services module 224, an internet scrubbing module 226, and a behavioral analysis module 228.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

In some embodiments, the database engine 204 may be in operable communication with an internet scrubbing module 226 or similar scrubbing tool capable of scrubbing various databases and sources of information to identify the user, individuals, or others. The internet scrubbing module 226 may be capable of searching for information contained in social media profiles, user profiles, etc.

In some embodiments, the image capture module 210 is operable to capture an image of an individual using the camera of a smart device (i.e., a smartphone, tablet, etc.). The image capture module 210 allows the user to capture the image of the individual which is then transmitted to the identification and verification module 214. The image capture may be stored in the database using the database engine 204.

In some embodiments, the identification and verification module 214 is used to provide a chain-of-custody for an item and/or an individual. This allows a user to monitor the transport of an item and/or an individual by first identifying a recipient of the item and/or individual, track the location throughout the transport of the item and/or individual, and then identify, verify, and confirm the receipt of the item and/or individual by a receiving party.

In some embodiments, the identification and verification module 214 allows users to scan another user and view a percentage of accuracy based on biometrics and the proximity, via a proximity detection module 222, of the person doing the scanning and location. The system may then provide an explanation of why the user was associated with the percentage.

In some embodiments, the identification and verification module 214 may verify the user's device to ensure that another individual does not attempt to create a duplicate account or otherwise impersonate the primary user. This may be accomplished by requiring the user to upload verified images and/or videos of themselves, or by otherwise authenticating their identity (e.g., via dual-factor authentication, location verification, security questions, etc.).

In some embodiments, the user module 212 facilitates the creation of a user account for the application system. The user module 212 may allow the user to input account information, establish user permissions and the like. The user module 212 may allow for two or more users to be associated with one another. For example, user 1 is married to user 2. As user 1 signs up for the application program, a notification is transmitted to user 2 via the communication module 202. This notification may be used to confirm that user 1 and user 2 are married.

In some embodiments, the user module 212 may allow two or more users to join accounts. Once accounts are joined, each user profile will be joined such that each user's information is displayed in a single joined user interface. Users may also have the option to unlink the profiles.

In another example, a laborer has been scheduled from a company to visit the home of user 1. Once the laborer presents themselves, user 1 captures an image of the laborer. This image is used to verify the identity of the laborer to provide peace-of-mind to the user.

In some embodiments, the identification and verification module 214 is operable to receive an image from the image capture module 210. The identification and verification module 214 then utilized facial recognition to verify the identity of the individual within the image. This is performed by analyzing the image and determining the identity of the individual using images stored in the database. If a match is determined, the identification and verification module 214 generates a report (e.g., the report may determine that there is a 99% likelihood that the image contains a certain user and provides the users name).

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged by the user.

In some embodiments, the sensor module 218 is operable to receive inputs from one or more sensors positioned within an environment. For example, the sensors may include cameras, motion sensors, proximity sensors, biometric scanners, and the like which allow the system to receive input from the sensors to identify and verify the identity of individuals as well as to identify items.

In some embodiments, the biometric analysis module 220 is operable to scan imagery of individuals to identify and verify individuals. Biometric sensors may include facial recognition cameras and associated software, retina scanning cameras and software, and the like. The biometric analysis module 200 may also be used to determine a number of individuals which are present in an environment.

In some embodiments, the biometric analysis module 220 may be used with a behavioral analysis module 228 to analyze user and/or individual(s) behaviors. This may include logging diary entries for specific interactions, flagging (whether automated or manual) of individuals, and to provide statistical insights related to user/individual patterns over time.

In some embodiments, a geolocation module 224 is operable to monitor user and/or individual locations in real-time. This enables the system to monitor the locations at which transactions took place, interactions took places, etc. The geolocation module 224 may also be used to alert users of changes (whether unexpected or expected) in locations, environments, etc. Interactions may then be reviewed and aggregated to generate trust scores which are visible on user profiles.

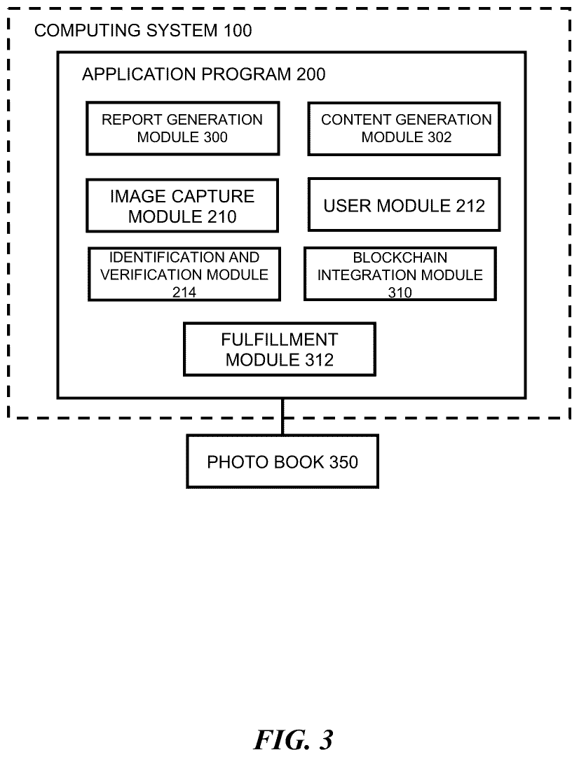

FIG. 3 illustrates a block diagram of the application program 200 operated by the computing system 100 which is used for the generation of a photo book 350. The identification and verification module 214 identifies and verifies individuals and manages a plurality of marketplace transactions. User-generated content is compiled via the user module and the application program includes a user interface module for providing access to the application program via the at least one user computing device. A report generation module 300 compiles and displays detailed transaction histories, including a plurality of sales data and plurality of purchases data. A content generation module 302 for compiling user-generated content into one or more customizable photo books. An image capture module 210 is operable to capture an image of an individual and reference the image of the individual with a database of images. A blockchain integration module stores a plurality of transaction metadata including a buyer identity and a seller identity, one or more time stamps, one or more transaction amounts, and one or more geolocations, wherein the plurality of transaction data is stored in a blockchain ledger via the blockchain integration module 310. Transaction reports are then displayed and may be searched by one or more search criteria including one of the following: a date range, a transaction type, and a counterparty. A fulfillment module 312 is capable of fulfilling orders for the photo book 350 which may be produced in physical and/or digitals formats.

In some embodiments, the system may transmit alerts which can indicate potential scams by analyzing discrepancies in identity or behavioral history.

In some embodiments, the system may scrub external data sources for fraudulent reports or suspicious activity linked to a profile.

In some embodiments, the system may combine geofencing, Bluetooth/ultrasound pings, and facial recognition to ensure all parties are verified during meetups.

In some embodiments, the system may send notifications to administrators if flagged profiles are involved in a transaction.

In some embodiments, the system includes API integration with social media platforms to enhance transaction security, provide verified badges, and display trust indicators.

The system may include a blockchain integration system which enables user registration and the creation of an account using personal details, performing live face scans, and verifying the user's identity. The blockchain wallet ID is generated for each user, linking the profile to a secure, decentralized identity. The blockchain ledger records user verification data (e.g., timestamps, hashes) to prevent identity fraud.

Users can create and share posts containing text, photos, videos, or events. Each post is assigned a unique blockchain identifier, which: Links metadata (e.g., creator ID, timestamp, privacy settings) to the post and ensures the post cannot be altered after submission.

Blockchain-based permissions allow users to share posts securely with specific friend lists or groups as well as track engagement (e.g., likes, comments, views) transparently.

A messaging system provide one-on-one and group messaging enabling users to communicate using encrypted public/private key cryptography. Metadata (e.g., sender, recipient, timestamp) is hashed and recorded on the blockchain for tamper-proof communication logs.

Users can audit message histories using the blockchain ledger. Deleted messages leave metadata intact for accountability. Group chats operate on a shared blockchain ledger, ensuring all participants receive the same, verified messages.

Market transactions involve creating listings including items services, or tickets posted for sale are recorded on the blockchain. This can include sellers verified identity, item metadata, and transaction information. Secure transactions are facilitated using smart contracts facilitate payment processing and delivery verification. Buyers and sellers can view transaction histories on the blockchain, ensuring transparency.

Dispute resolution is performed using immutable transaction records provide evidence for resolving disputes, protecting both buyers and sellers.

A photo book may be created which allows users to compile photo books using posts and shared content. The blockchain integration ensures the authenticity of photo metadata (e.g., upload date, creator identity, etc.).

In some embodiments, the blockchain integration system includes a decentralized ledger providing immutable storage for critical metadata (e.g., user actions, message timestamps, transaction details). Smart contracts provide automation for transactions and permissions (e.g., marketplace purchases, photo book creation).

A marketplace may be incorporated into the system for the purposes of creating, posting, and interacting with a listing for a good or service. When generating a profile to be used on the marketplace, a live face scan is performed for identity verification, linking the user's biometric data to their profile. Verified users gain access to the marketplace. Unverified users are restricted from creating listings or making purchases.

When creating a listing, verified users can create listings for items, services, or tickets. Users may enter item details (title, description, price, category, and photos). Delivery options are then specified (i.e., physical meeting, digital tender, etc.). The user undergoes a live face scan to authenticate their identity at the time of listing creation. Each listing is assigned a unique blockchain identifier, which includes: User ID of the seller, Timestamp of listing creation, and Detailed metadata about the item.

The marketplace may be used to enable buyers to initiate secure in-app messaging with sellers to ask questions or negotiate terms. Before enabling messaging, the system verifies both users' identities through their registered profiles. All communication is logged for security and future reference.

Once a buyer decides to purchase an item, the buyer initiates the transaction within the app and undergoes a live face scan for authentication. Next, the system processes payment securely using integrated payment gateways. The transaction is then logged on the blockchain ledger which records a unique transaction ID. Details of the item/service being sold, buyer and seller identities, and payment confirmation is also stored on the ledger. The buyer then confirms the purchase via the app, triggering a live face scan for transaction authorization. If the buyer and seller want to pay cash or another way they can—if a secure payment is needed: a Payment can be processed securely through the app, with blockchain integration to log: Transaction ID, Buyer and seller identities. Payment confirmation, and item or service details.

For physical goods, the buyer and seller coordinate a meeting location using the app's geolocation and proximity detection features—assist in coordinating a safe meeting location. At the time of pickup, both parties undergo live face scans to confirm their identities and log the transaction completion—this will be at the buyer and seller's discretion.

For digital goods or tickets, application program generates a blockchain-validated digital asset tied to the buyer's verified profile. Digital tickets are scanned and verified at the event location. The system generates a blockchain-validated ticket tied to the buyer's account, ensuring authenticity.

During post-transaction logging, a digital receipt is generated and stored in the buyer's and seller's profiles. The receipt includes blockchain validation details, a transaction ID and date, time, and geolocation data. Buyers and sellers can leave ratings and reviews, contributing to trust scores displayed on user profiles.

The system continuously monitors transactions using behavioral analysis modules to identify suspicious activities (e.g., frequent cancellations, mismatched face scans). If suspicious behavior is detected, the system flags the user and escalates the issue to administrators.

The system may include a posting feature, allowing users to share text updates, photos, videos, and events with their network. Unlike other platforms like LinkedIn or Facebook, the system will introduce an innovative “Create Book” feature that transforms user content into professional-quality photo books directly within the app.

The “Create Book” feature allows users to transform their social posts into professionally designed photo books. This feature combines advanced AI automation, drag-and-drop customization tools, and seamless integration with social posts, enabling users to preserve their most cherished memories with ease. From weddings and birthdays to vacations, users can select posts, arrange photos, and finalize layouts within the app. The feature also includes an in-app purchase system, a history of previous orders, and tools for editing and personalizing books, offering a unique combination of social media and physical memory preservation.

The create a book functionality allows users to: automatically generate photo books by selecting posts including associated photo/videos to create an album or book. Books may be customized to enable users to choose layouts, covers, and themes for their photo books.

The system also includes a friend connection system that allows users to create and manage friend lists, fostering social interaction and collaboration within the platform. Inspired by popular systems on LinkedIn and Facebook, the system enhances this functionality by integrating advanced privacy settings, two-way linking for friend approval, and categorization of friends into custom lists. These lists can be used to filter content, send group messages, and share posts with specific audiences, ensuring a highly personalized social experience.

In some embodiments, users can send and/or receive friend requests which must be accepted to establish a connection between users. Each party can view and interact with each other's posts, depending on their privacy settings. Users are able to categorize friend lists, filter users, send communications, establish privacy settings, receive friend suggestions,

The system includes a secure and versatile messaging system that allows users to communicate seamlessly within the platform. Designed to complement the app's social and transactional features, the messaging system enables one-on-one and group chats, integrates advanced privacy settings, and leverages multimedia sharing capabilities. The system also includes real-time notifications, message encryption for security, and the ability to link messages to other app features, such as posts, friend lists, and the marketplace. This messaging system enhances user engagement and fosters collaboration, making it an essential component of the platform.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for identifying individuals using facial recognition, the system comprising:
at least one user computing device in operable connection with a user network;
an application server in operable communication with the user network, the application server configured to host an application program for identifying and verifying individuals, the application program having a user interface module for providing access to the application program via the at least one user computing device;
a processor and a non-transitory, computer readable memory storing instructions that, when executed by the processor upon a user selection, cause the device to:
capture an image of an individual and reference the image of the individual with a database of images; and
verify, via an identification and verification module, the identity of the individual.

2. The system of claim 1, further comprising an image capture module capable of capturing an image of an individual in real-time, wherein a database engine transmits the image to the database of images to identify the individual.

3. The system of claim 2, further comprising an identification and verification module to receive the image and to identify and to verify the individual to determine if the individual has a permitted status or a non-permitted status.

4. The system of claim 1, further comprising a biometric analysis module in operable communication with the identification and verification module to identify and verify the individual using a plurality of biometric information.

5. The system of claim 1, further comprising a proximity detection module to determine a proximity of the individual to a pre-defined location.

6. The system of claim 5, further comprising a geolocation module to determine a location of the individual and reference the location with the proximity of the individual.

7. The system of claim 1, further comprising an internet scrubbing module to scrub one or more information sources to identify the individual.

8. The system of claim 1, further comprising a behavioral analysis module to analyze one or more behaviors of the individual.

9. A system for identifying individuals using facial recognition, the system comprising:
at least one user computing device in operable connection with a user network;
an application server in operable communication with the user network, the application server configured to host an application program for identifying and verifying individuals, the application program having a user interface module for providing access to the application program via the at least one user computing device;
a processor and a non-transitory, computer readable memory storing instructions that, when executed by the processor upon a user selection, cause the device to:
capture an image of an individual and reference the image of the individual with a database of images;
verify, via an identification and verification module, the identity of the individual;
transmit, via a communication module, one or more alerts to an administrator;
display, via a display module, the identity of the individual to the administrator; and
enable the administrator to contact a user if the individual is a non-permitted individual.

10. The system of claim 9, further comprising a blockchain-integrated system, comprising: a decentralized ledger for storing a plurality of user authentication data, a plurality of media content, a plurality of communications, and a plurality of transaction information.

11. The system of claim 10, further comprising a marketplace in operable communication with the blockchain-integrated system, wherein the marketplace enable the secure purchase of goods.

12. The system of claim 11, further comprising a social media platform in operable communication with at least one of the blockchain-integrated system or the marketplace, wherein the social media platform enables the secure interaction between a plurality of users.

13. The system of claim 12, wherein the marketplace enables users to create a photo book using selected content from the social media platform.

14. The system of claim 19, further comprising an identification and verification module to receive the image and to identify and to verify the individual to determine if the individual has a permitted status or a non-permitted status.

15. The system of claim 15, further comprising a biometric analysis module in operable communication with the identification and verification module to identify and verify the individual using a plurality of biometric information.

16. The system of claim 16, further comprising a proximity detection module to determine a proximity of the individual to a pre-defined location.

17. The system of claim 17, further comprising a geolocation module to determine a location of the individual and reference the location with the proximity of the individual.

18. The system of claim 18, further comprising an internet scrubbing module to scrub one or more information sources to identify the individual.

19. The system of claim 19, further comprising a behavioral analysis module to analyze one or more behaviors of the individual.

20. A system for identifying individuals and generating transaction reports and personalized photo books within a social commerce platform, the system comprising:
at least one user computing device in operable connection with a user network;
an application server in operable communication with the user network, the application server configured to host an application program for identifying and verifying individuals, managing a plurality of marketplace transactions, and compiling user-generated content the application program having a user interface module for providing access to the application program via the at least one user computing device;
a report generation module for compiling and displaying detailed transaction histories, including a plurality of sales data and plurality of purchases data;
a content generation module for compiling user-generated content into one or more customizable photo books;
a processor and a non-transitory, computer readable memory storing instructions that, when executed by the processor upon a user selection, cause the device to:
capture an image of an individual and reference the image of the individual with a database of images;
verify, via an identification and verification module, the identity of the individual;
store a plurality of transaction metadata including a buyer identity and a seller identity, one or more time stamps, one or more transaction amounts, and one or more geolocations, wherein the plurality of transaction data is stored in a blockchain ledger;
generate and display the one or more transaction reports each searchable by one or more search criteria including one of the following: a date range, a transaction type, and a counterparty;
compile a plurality of user-generated content into a customizable photo book;
securely log and validate ownership of a plurality of selected content via a blockchain to prevent unauthorized reproduction or replication of the photo book; and
enable fulfillment of the photo book in a digital format or a physical format.
